(19) United States
(12) Patent Application Publication
(10) Pub. No.: US 2011/0010704 A1
(43) Pub. Date: Jan. 13, 2011

(54) METHOD AND APPARATUS FOR INSTALLING APPLICATION USING APPLICATION IDENTIFIER

(75) Inventors: Jong Hong JEON, Daejeon (KR); Seung Yun LEE, Daejeon (KR); Won Suk LEE, Daejeon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, Daejeon (KR)

(21) Appl. No.: 12/770,966

(22) Filed: Apr. 30, 2010

(30) Foreign Application Priority Data
Jul. 8, 2009 (KR) 10-2009-0062192

(51) Int. Cl. G06F 9/445

(52) U.S. Cl. 717/178

(57) ABSTRACT

An application installation method and apparatus using an application identifier (AI) are disclosed. The application installation method includes: transmitting, by a terminal, an AI inputted by a user and terminal information to an installation information providing server; acquiring, by the installation information providing server, installation information corresponding to the AI and the terminal information, and transmitting the acquired installation information; and connecting, by the terminal, to an installation file providing server according to the installation information, downloading an installation file corresponding to the AI, and installing an application corresponding to the AI.

### CROSS-REFERENCE TO RELATED APPLICATIONS

This application claims the priority of Korean Patent Application No. 10-2009-0062192 filed on Jul. 8, 2009, in the Korean Intellectual Property Office, the disclosure of which is incorporated herein by reference.

### BACKGROUND OF THE INVENTION

1. Field of the Invention

The present invention relates to an application installation method and, more particularly, to an application installation method and apparatus using an application identifier capable of downloading an application installation file based on an application identifier and installing the downloaded file in a terminal.

2. Description of the Related Art

Recently, the growth of a ubiquitous communications environment has led to an increase in an environment in which terminals connected to various types of communications networks such as a mobile device, a desktop computer, a small device, and the like, are used for multiple purposes.

Also, various techniques allowing applications fitting terminals to be conveniently installed in such multiple terminal environments are being introduced.

In particular, a method of providing an application list through a system such as an application store and searching for and installing a desired application from the application list has recently become available.

However, the method of searching the list of numerous applications for an application fitting a terminal and installing it still causes user inconvenience in that users must check numerous applications on the list.

Thus, currently, various attempts are being made to allow for the easy and convenient identification and installation of an application.

### SUMMARY OF THE INVENTION

An aspect of the present invention provides an application installation method and an apparatus using an application identifier capable of receiving an application identifier from a user in the event of installing an application, and easily installing an application based on the received application identifier.

An aspect of the present invention also provides an application installation method and apparatus using an application identifier capable of installing an application in consideration of even the type of communications network to which a terminal is connected.

According to an aspect of the present invention, there is provided a terminal that is connected to one of a mobile communications network, a wireless local area network (WLNA), a wireline network, and the Internet in order to perform communications, including: an application installation management unit that receives installation information corresponding to an Application Identifier (AI) inputted by a user from an installation information providing server through an AI, connects to an installation file providing server according to the installation information to download an installation file corresponding to the AI, and installs an application corresponding to the AI; a download unit that is connected to the installation file providing server and downloads the installation file under the control of the application installation management unit; and an application platform and operating system that executes the application and provides the executed application to a user.

According to another aspect of the present invention, there is provided an installation information providing server including: an installation information management unit that registers, corrects and deletes the installation information of each application identifier (AI); an installation information searching unit that searches for installation information to be provided to a terminal in consideration of an AI transmitted from the terminal or the AI and terminal information; and an installation information transmission unit that provides the installation information which has been searched by the installation information searching unit to the terminal.

According to another aspect of the present invention, there is provided an application installation method using an application identifier (AI), including: transmitting, by a terminal, an AI inputted by a user to an installation information providing server; acquiring, by the installation information providing server, installation information corresponding to the AI and transmitting the acquired installation information; and connecting, by the terminal, to an installation file providing server, downloading an installation file corresponding to the AI, and installing an application corresponding to the AI.

According to another aspect of the present invention, there is provided an application installation method using an application identifier (AI), including: transmitting, by a terminal, an AI inputted by a user and terminal information to an installation information providing server; acquiring, by the installation information providing server, installation information corresponding to the AI and the terminal information, and transmitting the acquired installation information; and connecting, by the terminal, to an installation file providing server according to the installation information, downloading an installation file corresponding to the AI, and installing an application corresponding to the AI.

### BRIEF DESCRIPTION OF THE DRAWINGS

The above and other aspects, features and other advantages of the present application will be more clearly understood from the following detailed description taken in conjunction with the accompanying drawings, in which:

FIG. 1 illustrates the configuration of an application installation system using an application identifier (AI) according to an exemplary embodiment of the present invention.

FIG. 2a illustrates a detailed configuration of a terminal according to an exemplary embodiment of the present invention.

FIG. 2b illustrates a detailed configuration of an application installation management unit according to an exemplary embodiment of the present invention.

FIG. 2c illustrates an implementation example of a DB of FIG. 2b according to an exemplary embodiment of the present invention.

FIG. 3 illustrates the external appearances of a terminal according to an exemplary embodiment of the present invention.

FIG. 4a illustrates a detailed configuration of an installation information providing server according to an exemplary embodiment of the present invention.

FIG. 4b illustrates an implementation example of a DB of FIG. 4a according to an exemplary embodiment of the present invention.

FIG. 5 is a flow chart illustrating the process of an application installation method according to an exemplary embodiment of the present invention.

FIG. 6 is a flow chart illustrating the process of an application installation method according to an exemplary embodiment of the present invention.

### DETAILED DESCRIPTION OF THE PREFERRED EMBODIMENT

Exemplary embodiments of the present application will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

In addition, unless explicitly described to the contrary, the word “comprise” and variations such as “comprises” or “comprising,” will be understood to imply the inclusion of stated elements but not the exclusion of any other elements.

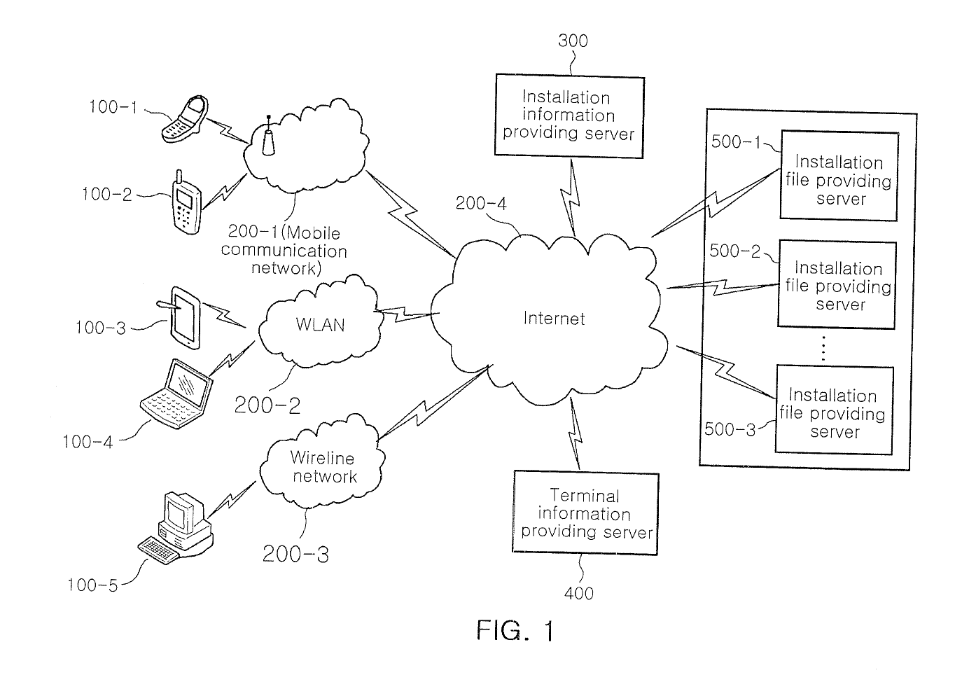

FIG. 1 illustrates the configuration of an application installation system using an application identifier (AI) according to an exemplary embodiment of the present invention.

With reference to FIG. 1, an application installation system includes a plurality of terminals 100-1˜100-5 connected to one of various types of communication networks 200-1˜200-4, and an installation information providing server 300, a terminal information providing server 400, and installation file providing servers 500-1˜500-3 which are connected to the Internet 200-4.

The plurality of terminals 100-1˜100-5 may be implemented as a mobile communications terminal connected to the mobile communications network 200-1, a mobile terminal connected to the WLAN 200-2, and a desktop computer and a set-top box (STB) connected to the wireline network 200-3.

When the user inputs an application identifier (AI) corresponding to an application desired to be installed, each of the terminals 100-1˜100-5 is relayed with an installation file providing path of the application corresponding to the AI from the installation information providing server 300 through the AI. Then, each terminal connects to the installation file providing server 300 corresponding to the relayed installation file providing path, downloads a desired installation file, and installs it within itself.

The AI is unique information previously set to identify an application, which is configured as a combination of numbers, characters, and symbols. In addition, the AI may be extended in the form of being combined with identification information such as an RFID code, one-dimensional/two-dimensional barcode, an image, GPS location information, and the like.

When a particular terminal (e.g., 100-1) transmits the AI to request the provision of the installation file providing path of the application corresponding to the AI, the installation information providing server 300 acquires installation information including corresponding information and provides the same to the corresponding terminal 100-1.

If the terminal 100-1 transmits terminal information in addition to the AI, the installation information providing server 300 acquires installation information fitting the terminal in consideration of even the characteristics (referred to as ‘terminal characteristics’, hereinafter, for the sake of brevity) of the communication network 200-1 to which the terminal 100-1 is connected, as well as the AI, and provides the acquired installation information. Accordingly, the terminal 100-1 can install an application fitting the characteristics of the terminal itself.

The terminal information providing server 400 stores and provides detailed terminal information of each terminal. In this case, the detailed terminal information includes a terminal manufacturer, a communications method, an operating system, a type of application used, hardware information, and the like.

Each of the installation file providing servers 500-1˜500-3 stores and provides an installation file of each application. In this case, the installation file of each application has a different download URL according to terminal characteristics and versions, so that the user can download an installation file of an application in consideration of the terminal characteristics and even an application version.

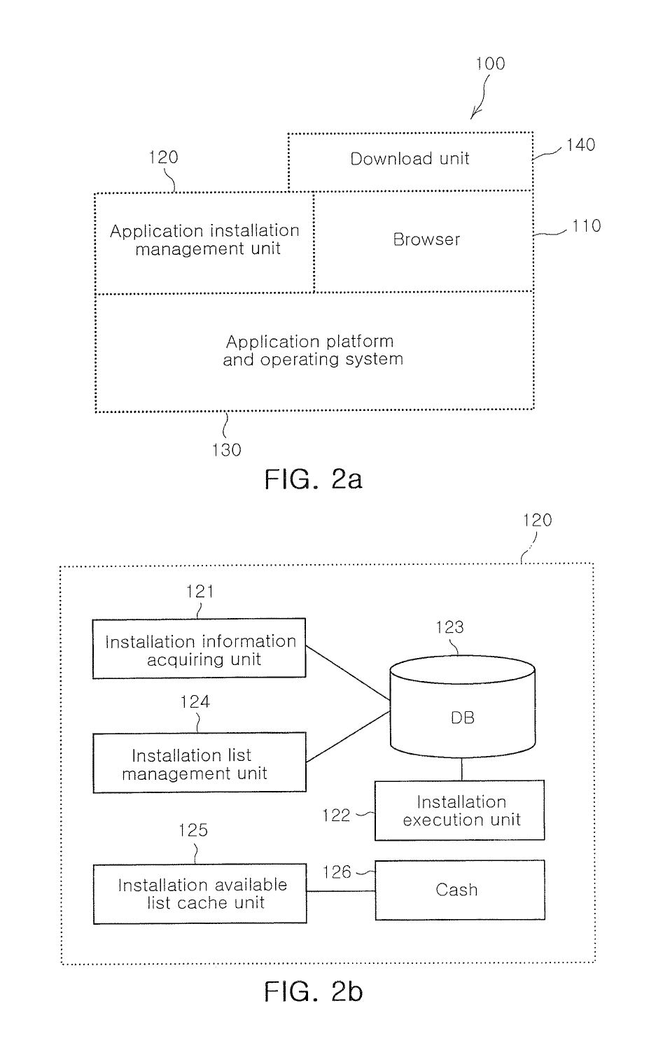

FIG. 2a illustrates a detailed configuration of the terminal according to an exemplary embodiment of the present invention.

With reference to FIG. 2a, the terminal 100 includes a browser 100, an application installation management unit 120, an application platform and operating system 130, and a download unit 140.

The browser 110 allows not only the user to view all of the information of a Web server to which the corresponding terminal 100 is connected, but also the user to perform information searching.

When an AI is inputted by the user, the application installation management unit 120 receives installation information corresponding to the AI from the installation information providing server 300 via the corresponding AI. The application installation management unit 120 then extracts an installation file URL from the installation information, connects to the extracted installation file URL, downloads an installation file corresponding to the AI through the download unit 140, and installs the downloaded installation file. In addition, the application installation management unit 120 transmits terminal information as well as the AI to the installation information providing server 300, so as to receive installation information fitting the characteristics of the terminal from the installation information providing server 300.

In this case, the installation information includes information regarding the AI, the name of an application, a manufacturer, a version, an installation file URL, a providing type (paid/free of charge), a purchasing price, and the like.

The application platform and operating system 300 substantially executes the application installed within the terminal 100, for the user service.

The download unit 140 connects to the installation file providing server having an installation file URL and downloads an installation file corresponding to the AI under the control of the application installation management unit 120. IN this case, the download unit 140 may download the installation file by using a download plug-in operating over the browser 110 or a download protocol such as a file transfer protocol (FTP).

FIG. 2b illustrates a detailed configuration of the application installation management unit according to an exemplary embodiment of the present invention.

With reference to FIG. 2b, the application installation management unit 120 includes an installation information acquiring unit 121, an installation execution unit 122, and a database (DB) 123.

When an AI is inputted by the user, the installation information acquiring unit 121 transmits the AI or the AI and terminal information to the installation information providing server 300 to request and acquire installation information corresponding to the AI. In addition, if an application corresponding to the AI has been previously installed, the installation information acquiring unit 121 checks whether the application is to be re-installed or updated, and acquires an installation file for re-installing or updating the application through the installation information providing server 300.

The installation execution unit 122 extracts an installation file URL from the installation information which has been acquired by the installation information acquiring unit 121, connects to the installation file providing server retaining the installation file URL, downloads a corresponding installation file, and installs it. In addition, the installation execution unit 122 records installation content in the DB 123 so as to utilize it in re-installing or updating the corresponding application.

The DB 123 stores all of the information regarding applications installed within the terminal 100.

The application installation management unit 120 may further include an installation list management unit 124, an installation available list cache unit 125, and a cache 126 in order to provide supplementary information in relation to an application installation to the user.

The installation list management unit 124 manages and maintains the list of applications installed within the terminal by AIs, and minutely records system change particulars and the like in the DB 123.

The installation available list cache unit 125 caches the list of installation-available applications provided from the installation information providing server 300 in the cache 126, so as to quickly provide the installation-available list to the user upon reception of a corresponding request.

FIG. 2c illustrates an implementation example of the DB 123 of FIG. 2b according to an exemplary embodiment of the present invention.

As shown in FIG. 2c, all of the information regarding an application, for which an application installation operation has been performed, is classified by AIs and stored.

The application information of each AI includes an AI, the name of an application, a manufacturer, a version, an installation date, an installation file URL, a providing type (paid/free of charge), a purchasing price, an installation file list, other detailed information, and the like.

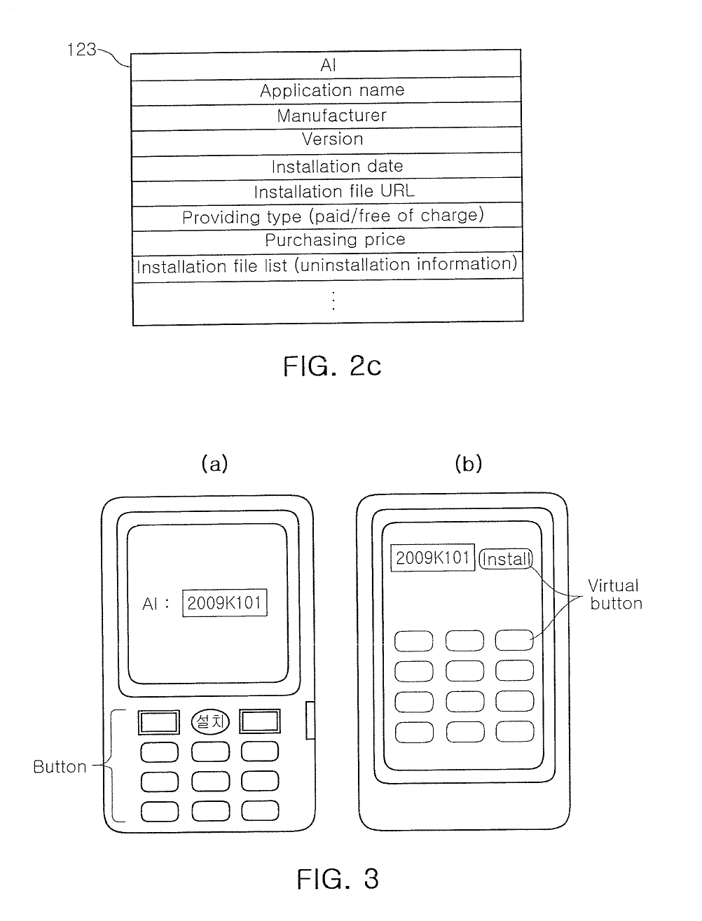

FIG. 3 illustrates the external appearances of a terminal according to an exemplary embodiment of the present invention.

An input method of the terminal 100 according to an exemplary embodiment of the present invention may be implemented as a button input method, a touch screen input method, a mixture method of the button input method and the touch screen input method, and the like.

If the terminal is implemented based on the button input method as shown in FIG. 3(a), the user may input an AI corresponding to an application desired to be installed by pressing key buttons corresponding to numbers, characters, and symbols, and request installation of the corresponding application by pressing key buttons corresponding to an installation function.

Similarly, if the terminal is implemented based on the touch screen input method as shown in FIG. 3(b), the user may touch virtual buttons implemented such that they correspond to the numbers, characters, symbols and an installation function on a certain area of a touch screen to input an AI and request the installation of a corresponding application.

Namely, the terminal according to an exemplary embodiment of the present invention may input an AI regardless of an input method, and request installation of an application corresponding to the AI.

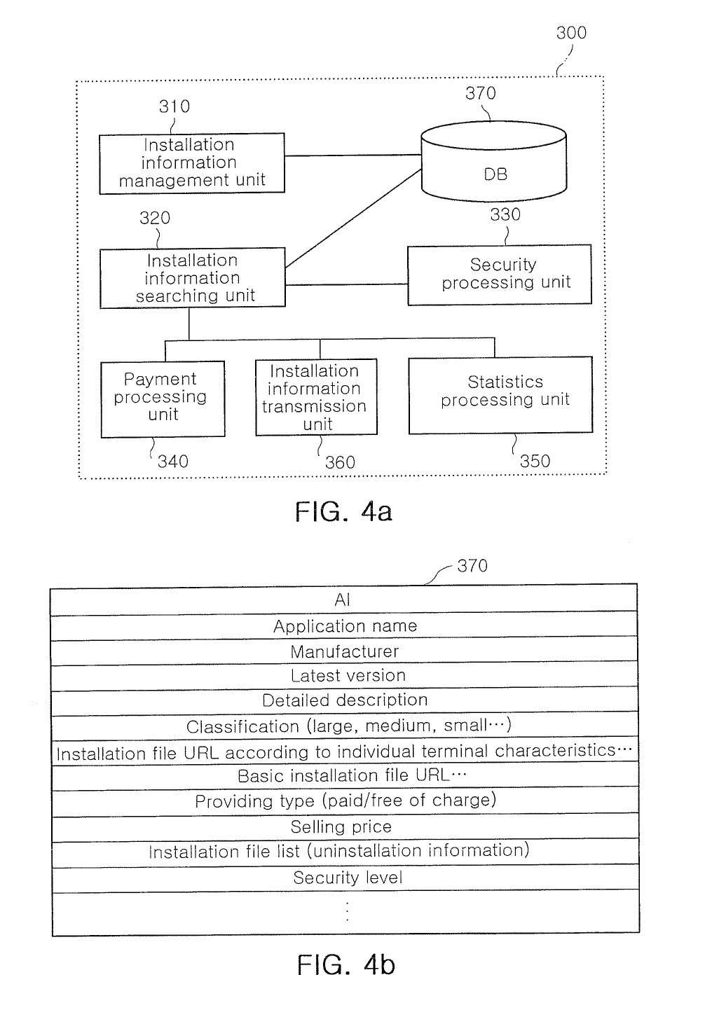

FIG. 4a illustrates a detailed configuration of the installation information providing server according to an exemplary embodiment of the present invention.

With reference to FIG. 4a, the installation information providing server 300 includes an installation information management unit 310, an installation information searching unit 320, an installation information transmission unit 330, a payment processing unit 340, a security processing unit 350, a statistics processing unit 360, and a DB 370.

The installation information management unit 310 performs a management operation of registering, correcting and deleting installation information with respect to an application that can be installed in the terminal connected to an application installation system by AIs.

The installation information searching unit 320 searches installation information to be provided to the terminal in consideration of the AI or the AI and the terminal information transmitted from the terminal. In more detail, when the terminal requests the provision of installation information by using only the AI, the installation information searching unit 320 searches the DB 370 to acquire installation information including a basic installation file URL. Meanwhile, if the terminal requests the provision of installation information by using the AI and the terminal information, the installation information searching unit 320 acquires detailed terminal information defining terminal characteristics from the terminal information providing server 400 through the terminal information, and searches the DB 370 to acquire installation information including an installation file URL satisfying the terminal characteristics according to the detailed terminal information.

The installation information transmission unit 330 transmits the installation information which has been searched through the installation information searching unit 320 to the corresponding terminal.

If the installation information to be provided to the terminal 100 is paid information, the payment processing unit 340 performs a payment procedure according to the provision of information by interworking with an electronic payment system.

The security processing unit 330 manages and protects the authority of accessing the installation information, and the statistics processing unit 360 analyzes requests, processing records, and the like, with respect to every application managed, searched and transmitted through the installation information providing server 300 and the terminal to produce and provide various statistics information.

The DB 370 stores all of the information for providing installation information corresponding to the AI or the AI and the terminal information. Namely, the DB 370 stores all of the information regarding applications that can be installed in the terminal connected to the application installation system.

FIG. 4b illustrates an implementation example of a DB of FIG. 4a according to an exemplary embodiment of the present invention.

As shown in FIG. 4b, the DB 370 stores all of the information regarding applications, which can be installed in the terminal connected to the application installation system, as classified by AIs. The application information of each AI includes an AI, the name of an application, a manufacturer, a version, a detailed description, classification (large, medium, small), an installation file URL according to respective terminal characteristics, a basic installation file URL, a providing type (paid/free of charge), selling price, an installation file list, a security level, and other detailed information.

With reference to FIG. 4b, it is noted that the application information of each AI includes an installation file URL according to respective terminal characteristics. Namely, the application information of each AI has mutually different installation file URLs according to respective terminal characteristics. Thus, when the terminal transmits both the AI and the terminal information, the installation information providing server 300 selects only one of the plurality of installation file URLs according to the plurality of terminal characteristics by using the terminal information, and provides installation information including the same to the terminal, to allow the terminal to install an installation file suitable for its terminal characteristics.

Also, it is noted that the application information of each AI includes information regarding the basic installation file URL besides the installation file URL of the respective terminal characteristics. Accordingly, when the terminal transmits only the AI, the installation information providing server 300 provides installation information including the basic installation file URL, to allow the terminal to receive and install a desired installation file by using only the AI.

In addition, it is noted that the application information of each AI includes information regarding the latest version. When the terminal requests it, information about the latest version of an application is provided to the terminal, so that the terminal can determine whether to re-install or update the corresponding application.

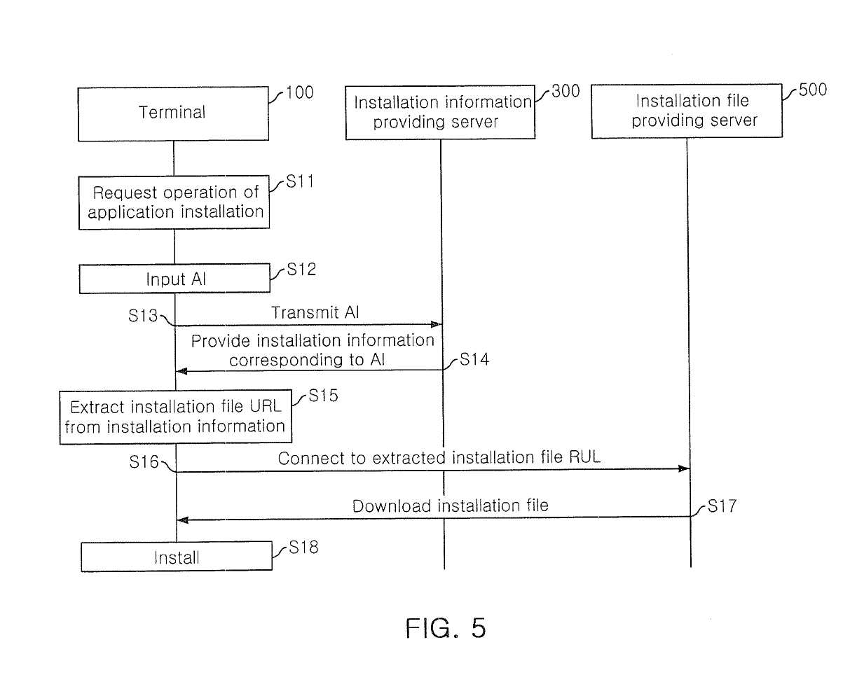

FIG. 5 is a flow chart illustrating the process of an application installation method using only an AI according to an exemplary embodiment of the present invention.

First, when the user requests an application installation operation (S11) and inputs an AI corresponding to an application desired to be installed (S12), the terminal 100 transmits the inputted AI to the installation information providing server 300 to request the provision of installation information (S13).

The installation information providing server 300 searches the DB 370 to acquire installation information corresponding to the AI, and provides the corresponding installation information to the terminal 100 (S14).

Upon receiving the installation information, the terminal 100 extracts an installation file URL from the received installation information (S15), connects to the installation file providing server retaining the extracted installation file URL (S16), downloads a desired installation file (S17), and installs it (S18).

In this manner, in the exemplary embodiment of the present invention, when the user inputs an AI, installation information corresponding to the AI is received through the installation information providing server and the installation file providing server is connected based on the installation information to download and install a desired installation file.

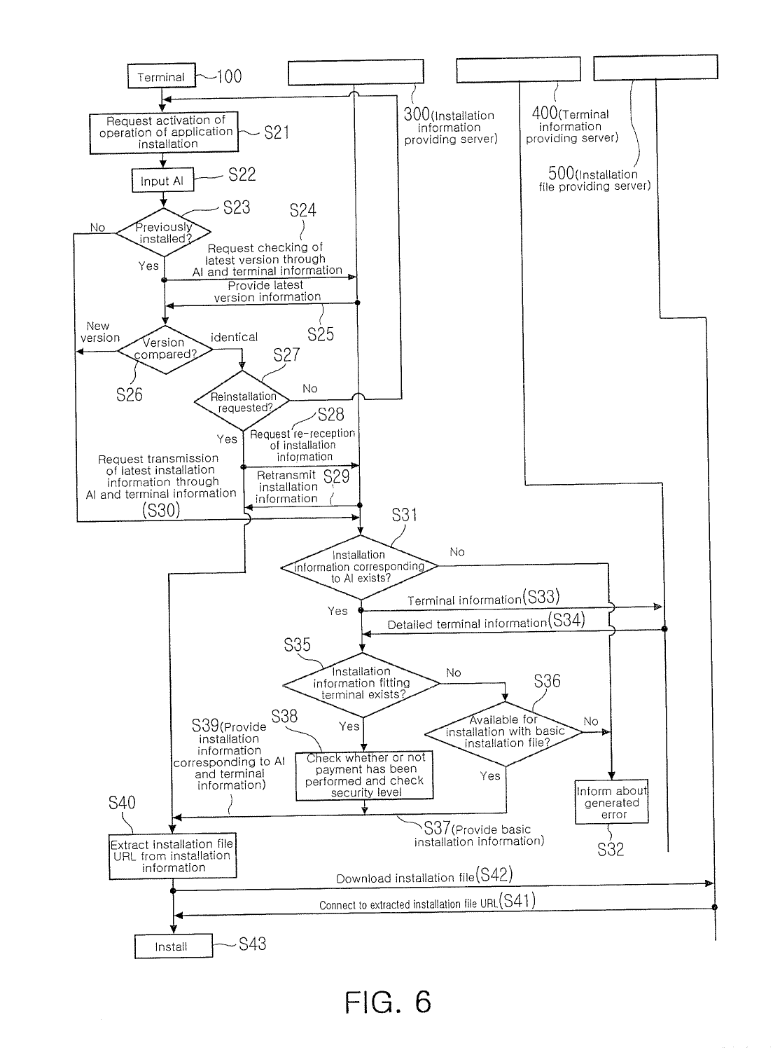

FIG. 6 is a flow chart illustrating the process of an application installation method using the version information of an application previously installed within the terminal and terminal information in addition to an AI, according to an exemplary embodiment of the present invention.

First, when the user requests an application installation operation (S11) and inputs an AI corresponding to an application desired to be installed (S12), the terminal 100 checks whether an application corresponding to the AI has been installed (S23).

If the application has been installed, the terminal 100 transmits the AI and terminal information to the installation information providing server 300 to request the checking of the latest version of the corresponding application (S24).

The installation information providing server 300 acquires the latest version information corresponding to the AI and transmits the same to the terminal 100 (S25). Then, the terminal 100 compares the latest version information transmitted from the installation information providing server 300 with version information of the installed application (S26).

If the two versions are identical, the terminal 100 inquires to the user as to whether the application is to be re-installed (S27). If the user requests re-installation of the application, the terminal 100 requests re-reception of installation information from the installation information providing server 300 through the AI and the terminal information (S28), and the installation information providing server 300 re-transmits the corresponding installation information in response (S29).

Meanwhile, in case of a new version, the terminal 100 requests transmission of the latest installation information from the installation information providing server 300 through the AI and the terminal information (S30).

Then, the installation information providing server 300 checks whether there is installation information corresponding to the AI (S31). If there is no corresponding installation information, the installation information providing server 300 informs the user of an error generation (S32). If there is corresponding installation information, the installation information providing server 300 requests the searching of detailed terminal information from the terminal information providing server 400 through the received terminal information (S33).

When the terminal information providing server 400 provides detailed terminal information (S34), the installation information providing server 300 recognizes terminal characteristics through the detailed terminal information, and checks whether or not there is an installation file URL corresponding to the recognized terminal characteristics (Namely, the installation information providing server 300 checks as to whether or not there is installation information suitable for the terminal 100) (S35).

If there is no installation information suitable for the terminal 100, the installation information providing server 300 checks whether or not it can be installed with the basic installation file (S36), and provides installation information including a URL of the basic installation file to the terminal 100 (S37).

Meanwhile, if there is installation information suiting for the terminal 100, the installation information providing server 300 checks a provision type (i.e., paid/free of charge) and a security level of the corresponding application to process a cost and an access authority (S38) and provides installation information including an installation file URL corresponding to the AI and the detailed terminal information to the terminal 100 (S39).

Upon receiving the installation information, the terminal 100 extracts the installation file URL from the installation information (S40), connects to the extracted installation file URL (S41), and downloads and installs a desired installation file within the terminal (S42, S43).

In this manner, the method illustrated in FIG. 6 allows the application installation operation to be performed more accurately and minutely in consideration of the version information of the application previously installed within the terminal and the terminal information in addition to the AI.

In the above description, the steps are sequentially illustrated and performed, but in an actual application case, obviously, the steps may be performed in a different order, several times, and in parallel.

Also, although omitted in the above description, if the information input in steps S12 and S22 is not an AI, it may be checked as to whether or not the information corresponds to a voice call, the calling of a mobile address (WINC), other application interworking functions, and the like, generally installed within the terminal, and a corresponding procedure may be performed.

As set forth above, according to the application installation method and apparatus using an application identifier (AI) of the present invention, when the user inputs only an AI, he can be provided with installation information corresponding to the AI through an installation information providing server, and connect to an installation file providing server based on the installation information to download and install a desired installation file. Because the user merely needs to input the AI, user convenience can be maximized. In particular, in an environment in which a small screen such as that of a mobile terminal and an inconvenient user interface are used, one of a range of rapidly multiplying applications can be installed more conveniently and easily.

In addition, because the user can be provided with installation information in consideration of even the type of communications network to which the terminal is connected, and connect to the installation file providing server based on the received installation information to download and install a desired installation file, the present invention can be easily applicable for an environment in which terminals connected to various types of communications networks can be used is a composite and complex manner.

Moreover, an AI can be extended in the form being combined with identification information such as an RFID code, a one-dimensional/two-dimensional barcode, and an image, as well as GPS location information to allow for the installation of an application even through RFID, a one-dimensional/two-dimensional barcode, image recognition, and a location identification operation, whereby the AL can be useful for the ubiquitous environment.

While the present invention has been shown and described in connection with the exemplary embodiments, it will be apparent to those skilled in the art that modifications and variations can be made without departing from the spirit and scope of the invention as defined by the appended claims.

What is claimed is:

1. A terminal that is connected to one of a mobile communication network, a wireless local area network (WLNA), a wireline network, and the Internet in order to perform communications, the terminal comprising:
an application installation management unit that receives installation information corresponding to an Application Identifier (AI) inputted by a user from an installation information providing server through an AI, connects to an installation file providing server according to the installation information to download an installation file corresponding to the AI, and installs an application corresponding to the AI;
a download unit that is connected to the installation file providing server and downloads the installation file under the control of the application installation management unit; and
an application platform and operating system that executes the application and provides the executed application to a user.

2. The terminal of claim 1, wherein the application installation management unit further has a function of additionally transmitting terminal information besides the AI to the installation information providing server to allow the installation information providing server to provide the installation information in consideration of both the AI and the terminal information.

3. The terminal of claim 2, wherein the application installation management unit comprises:
an installation information acquiring unit that acquires the installation information from the installation information providing server through the AI inputted by the user or the AI and the terminal information; and
an installation execution unit that extracts a uniform resource locator (URL) from the installation information, connects to an installation file providing server retaining the installation file URL, and downloads and installs the installation file.

4. The terminal of claim 3, wherein if the application has been previously installed, the installation information acquiring unit receives information about the latest version from the installation information providing server to check whether or not the application should be re-installed or updated, and acquires an installation file for re-installing or updating the application.

5. The terminal of claim 3, wherein the application installation management unit comprises:
an installation list management unit that manages and maintains a list of applications installed in the terminal;
an installation available list cache unit that receives a list of applications available for installation from the installation information providing server and caches the same; and
a database that stores every information regarding applications installed in the terminal.

6. The terminal of claim 1, wherein the AI is configured as a combination of numbers, characters, and symbols, and is extendable in the form of being combined with identification information such as an RFID code, a one-dimensional/two-dimensional barcode, an image, or GPS location information.

7. An installation information providing server comprising:
an installation information management unit that registers, corrects and deletes the installation information of each application identifier (AI);
an installation information searching unit that searches for installation information to be provided to a terminal in consideration of an AI transmitted from the terminal or the AI and terminal information; and
an installation information transmission unit that provides the installation information which has been searched by the installation information searching unit to the terminal.

8. The server of claim 7, wherein when the terminal transmits only the AI, the installation information searching unit searches installation information including only a basic uniform resource locator (URL), and when the terminal transmits the AI and the terminal information, the installation information searching unit acquires detailed terminal information from the terminal information providing server through the terminal information and searches installation information including an installation file URL satisfying terminal characteristics according to the detailed terminal information.

9. The server of claim 7, further comprising:
a database that stores information for providing installation information corresponding to the AI or the AI and terminal information;
a payment processing unit that performs a payment procedure if installation information to be provided to the terminal is paid information;
a security processing unit that manages and protects authority of accessing the installation information; and
a statistics processing unit that analyzes every application managed, searched, and transmitted through the installation information providing server, and a request and processing record with respect to the terminal to create and provide statistics information.

10. The server of claim 9, wherein the database stores an AI, an application name, a manufacturer, a version, a detailed description, classification (large, medium, small), an installation file URL according to the characteristics of each terminal, a basic installation file URL, a providing type (paid/free of charge), a selling price, an installation file list, a security level, and other detailed information.

11. The server of claim 7, wherein the terminal is connected to one of a mobile communication network, a wireless local area network (WLAN), a wireline network, and the Internet.

12. The server of claim 7, wherein the AI is configured as a combination of numbers, characters, and symbols, and is extendable in the form of being combined with identification information such as an RFID code, a one-dimensional/two-dimensional barcode, an image, GPS location information.

13. An application installation method using an application identifier (AI), the method comprising:
transmitting, by a terminal, an AI inputted by a user to an installation information providing server;
acquiring, by the installation information providing server, installation information corresponding to the AI and transmitting the acquired installation information; and
connecting, by the terminal, to an installation file providing server, downloading an installation file corresponding to the AI, and installing an application corresponding to the AI.

14. The method of claim 13, wherein the AI is configured as a combination of numbers, characters, and symbols, and is extendable in the form of being combined with identification information such as an RFID code, a one-dimensional/two-dimensional barcode, an image, or GPS location information.

15. An application installation method using an application identifier (AI), the method comprising:
transmitting, by a terminal, an AI inputted by a user and terminal information to an installation information providing server;
acquiring, by the installation information providing server, installation information corresponding to the AI and the terminal information, and transmitting the acquired installation information; and
connecting, by the terminal, to an installation file providing server according to the installation information, downloading an installation file corresponding to the AI, and installing an application corresponding to the AI.

16. The method of claim 15, wherein the AI is configured as a combination of numbers, characters, and symbols, and is extendable in the form of being combined with identification information such as an RFID code, a one-dimensional/two-dimensional barcode, an image, GPS location information.

17. The method of claim 15, wherein the acquiring and transmitting the installation information comprises:
acquiring detailed terminal information from a terminal information providing server through the terminal information; and
acquiring installation information corresponding to the AI and the terminal information in consideration of the AI of the terminal and the detailed terminal information, and transmitting the same.

18. The method of claim 17, wherein the acquiring and transmitting the installation information comprises:
if there is no installation information corresponding to the AI and the terminal information, acquiring installation information including a URL of a basic installation file and transmitting the same.

19. The method of claim 15, further comprising:
if an application corresponding to the AI has been previously installed before the AI and the terminal information are transmitted to the installation information providing server, checking, by the terminal, the latest version through the installation file providing server to check whether or not the AI should be re-installed or a new AI should be installed.
